(19) United States
(12) Patent Application Publication
(10) Pub. No.: US 2012/0103962 A1
(43) Pub. Date: May 3, 2012

(54) COMPUTER KEYBOARD

(75) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/077,907

(22) Filed: Mar. 31, 2011

(30) Foreign Application Priority Data
Oct. 27, 2010 (CN) 201010521536.X

(51) Int. Cl. H05B 3/00

(52) U.S. Cl. 219/209

(57) ABSTRACT

A computer keyboard includes a body portion and a heating tray. The body portion is arranged with keys for performing typical keyboard functions. The heating tray includes a universal serial bus (USB) interface, a left wrist rest that is shaped to support a left wrist of a user, and a right wrist rest that is shaped to support a right wrist of the user. Each of the wrist rests includes a heating element that connects with an USB power supply for providing electrical energy to the heating tray. Each of the heating elements converts the electrical energy to heat when the USB power supply is plugged into the heating tray via the USB interface, and heats the respective wrist rests to a predefined temperature range.

### BACKGROUND

1. Technical Field

Embodiments of the present disclosure relate to computer peripheral devices, and more particularly to a computer keyboard.

2. Description of Related Art

Many computer users access and interact with a computer device for a long period of time while working. Interaction with the computer device via a keyboard requires the users to use repetitive motions for a sustained time. It is common for the user's fingers and hands to become uncomfortably cold and stiff especially during cold weather. Such stiffness and discomfort may become so overwhelming that it can influence the user's health, and impair or otherwise affect the user's efficiency.

Accordingly, there is a need to provide a solution for computer users as well as others who engage in repetitive manual operations, such as the operation of a keyboard.

### BRIEF DESCRIPTION OF THE DRAWINGS

FIG. 1 is a schematic diagram illustrating one embodiment of a computer keyboard.

FIG. 2 is a schematic diagram illustrating one embodiment of internal structure of the computer keyboard of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

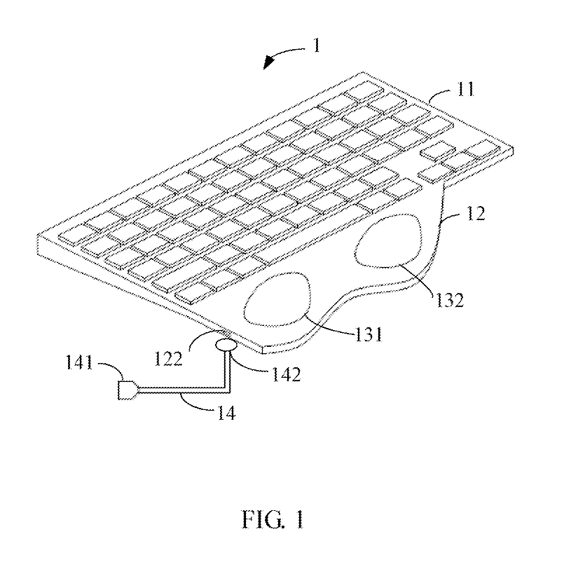

FIG. 1 is a block diagram of one embodiment of a computer keyboard 1. In the embodiment, the computer keyboard 1 includes a body portion 11 and a heating tray 12. The body portion 11 is arranged with a plurality of traditional keys that perform typical keyboard functions, such as number keys, character keys, and function keys. The heating tray 12 is located beside the body portion 11 to accommodate an orientation of a user's hands/wrists when orientating the computer keyboard 1 (hereinafter “the operation orientation”). It is understood that the operation orientation may be defined as a direction towards a user during the time the user operates the computer keyboard 1. Either the body portion 11 or the heating tray 12 can be made from hard materials, such as stainless steel or hard plastic materials.

In one embodiment, the heating tray 12 includes a left wrist rest 131, a right wrist rest 132, and an universal serial bus (USB) interface 122. In order to support left and right wrists of the user during operations of the computer keyboard 1, the left wrist rest 131 is generally concaved shaped according to a left wrist shape of the user, and the right wrist rest 132 is generally concaved shaped according to a right wrist shape of the user. In the embodiment, each of the wrist rests 131, 132 can be made using soft plastic or rubber materials with heat conduction. During the process of operating the computer keyboard 1, the left wrist can put on the left wrist rest 131 and the right wrist can put on the right wrist rest 132, so as to warm the user's fingers and hands to become more comfortable. Such comfort can decrease the probability of distortion of the user's wrists.

The USB interface 122 is located on the left side of the heating tray 12, and connects with a USB power supply 14 that provides power to the heating tray 12. In the embodiment, one port 141 of the USB power supply 14 may connect to an external power supply, and the other port 142 of the USB power supply 14 connects to the heating tray 12 via the USB interface 122. The heating tray 12 may be heated when the USB power supply 14 is plugged into the external power supply via the USB interface 122, and may stop heating when the USB power supply 14 is disconnected from the USB interface 122.

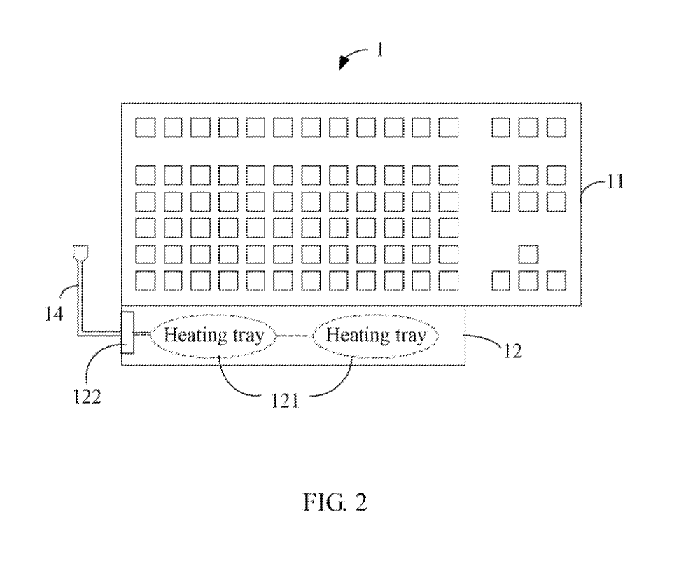

FIG. 2 is a schematic diagram illustrating one embodiment of an internal structure of the computer keyboard 1 of FIG. 1. In the embodiment, each of the left wrist rest 131 and the right 132 includes a heating element 121 that is embedded in the respective wrist rest 131, 132. Each of the heating elements 121 may be a heating circuit including one or more resistors, capacitors, and inductors. Each of the heating elements 121 converts electrical energy into heat when the USB power supply 14 is plugged into the USB interface 122, and heats the respective wrist rest 131, 132 to a predefined temperature range adapted to the user's body.

The temperature range may be between 36-37.5 degrees Celsius, which can warm the left and right wrists of the user comfortably and gently when the user operates the computer keyboard 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computer keyboard, comprising:
a body portion being arranged with a plurality of keys; and
a heating tray comprising a universal serial bus (USB) interface, a left wrist rest that is shaped to support a left wrist of a user, and a right wrist rest that is shaped to support a right wrist of the user; wherein:
each of the wrist rests comprises a heating element that connects with a USB power supply for providing electrical energy to the heating tray; and
each of the heating elements converts the electrical energy into heat when the USB power supply is plugged into the heating tray via the USB interface, and heats each of the wrist rests to a predefined temperature range.

2. The computer keyboard according to claim 1, wherein the left wrist rest is concaved shaped according to a left wrist shape of the user, and the right wrist rest is concaved shaped according to a right wrist shape of the user.

3. The computer keyboard according to claim 1, wherein the left wrist rest and the right wrist rest are made using a soft plastic or rubber materials with heat conduction.

4. The computer keyboard according to claim 1, wherein each of the heating elements is a heating circuit comprising one or more resistors, capacitors, and inductors.

5. The computer keyboard according to claim 1, wherein one port of the USB power supply connects to an external power supply, and the other port of the USB power supply connects to the heating tray via the USB interface.

6. The computer keyboard according to claim 1, wherein the USB interface is located on a left side of the heating tray.

7. The computer keyboard according to claim 1, wherein the heating tray is located beside the body portion.

8. The computer keyboard according to claim 1, wherein the predefined temperature range is between 36-37.5 degrees Celsius.
